(19) United States
(12) Patent Application Publication
(10) Pub. No.: US 2026/0066694 A1
(43) Pub. Date: Mar. 5, 2026

(54) SUSTAINABILITY INDICATOR FOR POWER DEVICE

(71) Applicant: SCHNEIDER ELECTRIC IT CORPORATION, Foxboro, MA (US)

(72) Inventor: Himamshu Viswathmula Prasad, Andover, MA (US)

(21) Appl. No.: 18/816,002

(22) Filed: Aug. 27, 2024

(51) Int. Cl. H02J 13/00

(52) U.S. Cl. CPC H02J 13/10

(57) ABSTRACT

A system includes a controller configured to request power-source data associated with a plurality of power sources powering a device, assigning sustainability factors associated with the power-source data, determine a sustainability indicator based on the plurality of sustainability factors, and output the sustainability indicator. The system further may include a display configured to display the sustainability indicator. The display may include a user interface of a power device or a remote device. The remote device may include one of a smartphone, tablet, laptop, notebook or personal computer having a monitor. The sustainability indicator may include one or more icons representing a source of electricity based on the plurality of sustainability factors.

### BACKGROUND

### 1. Field of Invention

Aspects and embodiments of the present disclosure are directed to power devices, and more particularly to a power device having a user interface or display configured to provide a sustainability indicator to the operator of the power device.

### 2. Discussion of Related Art

Operators of power devices, such as uninterruptible power supplies (UPSs), power distribution units (PDUs), and other types of equipment, are unaware of the source of power used by the device, especially since the source of power can change during the course of the day. Such devices include user interfaces to communicate information to the operators. Presently, power supply companies, such as utility power companies, provide information about the source of power to consumers, but this information is not available for a particular power device.

### SUMMARY

One aspect of the present disclosure is directed to a system comprising a controller configured to request power-source data associated with a plurality of power sources powering a device, assigning sustainability factors associated with the power-source data, determine a sustainability indicator based on the plurality of sustainability factors, and output the sustainability indicator.

Embodiments of the system further may include a display configured to display the sustainability indicator. The display may include a user interface of a power device. The display may include a user interface of a remote device. The remote device may include one of a smartphone, tablet, laptop, notebook or personal computer having a monitor. The sustainability indicator may include one or more icons representing a source of electricity based on the plurality of sustainability factors. The source of electricity may include coal, natural gas, a hybrid source, and a clean source. The controller further may be configured to store the power-source data and generate periodic reports. The controller further may be configured to generate a signal based on a change in the plurality of sustainability factors. The controller further may be configured to control the operation of the device based on the sustainability indicator.

Another aspect of the present disclosure is directed to a method of providing a sustainability indicator of a power source. In one embodiment, the method comprises: requesting power-source data associated with a plurality of power sources powering a device; assigning a plurality of sustainability factors associated with the power-source data; determining a sustainability indicator based on the plurality of sustainability factors; and outputting the sustainability indicator.

Embodiments of the method further may include displaying the sustainability indicator. The sustainability indicator may be displayed on a user interface of a power device. The sustainability indicator may be displayed on a user interface of a remote device. The remote device may include one of a smartphone, tablet, laptop, notebook or personal computer having a monitor. The sustainability indicator may include one or more icons representing a source of electricity. The source of electricity may include coal, natural gas, a hybrid source, and a clean source. The method further may include storing the power-source data and generating periodic reports. The method further may include generating a signal based on a change in the plurality of sustainability factors. The method further may include controlling the operation of the device based on the sustainability indicator.

Yet another aspect of the present disclosure is directed to a computer readable medium configured to cause a controller to perform a method of providing a sustainability indicator of a power source. In one embodiment, the method comprises: requesting power-source data associated with a plurality of power sources powering a device; assigning a plurality of sustainability factors associated with the power-source data; determining a sustainability indicator based on the plurality of sustainability factors; and outputting the sustainability indicator.

Embodiments of the computer-readable medium further may include displaying the sustainability indicator. The sustainability indicator may be displayed on a user interface of a power device. The sustainability indicator may be displayed on a user interface of a remote device. The remote device may include one of a smartphone, tablet, laptop, notebook or personal computer having a monitor. The sustainability indicator may include one or more icons representing a source of electricity. The source of electricity may include coal, natural gas, a hybrid source, and a clean source. The computer-readable medium further may include storing the power-source data and generating periodic reports. The computer-readable medium further may include generating a signal based on a change in the plurality of sustainability factors. The computer-readable medium further may include controlling the operation of the device based on the sustainability indicator.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is perspective view of an exemplary power device including a display configured to display sustainability indicators of power sources of embodiments of the present disclosure;

FIG. 2 are views of displays of remote devices, such as a screen monitor, a laptop, and a handheld device, each of which are configured to display sustainability indicators of power sources of embodiments of the present disclosure;

FIG. 3 is a view showing a sustainability indicator of one embodiment of the present disclosure;

FIG. 4 is a diagram of a method of providing a sustainability indicator of a power source; and

FIG. 5 is a block diagram of a computer system included in embodiments of systems disclosed herein.

The patent or application file contains at least one drawing executed in color. Copies of this patent or patent application publication with color drawing(s) will be provided by the Office upon request and payment of the necessary fee.

### DETAILED DESCRIPTION

This disclosure is not limited in its application to the details of construction and the arrangement of components set forth in the following description or illustrated in the drawings. The disclosed systems and methods are capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Customers are unaware of the source of power especially since the source of power can change during the course of the day. A visual indicator is way to promote sustainability by creating awareness and potentially drive customers to demand sustainable power. Providing a real-time visual (sustainability) indicator creates an awareness to customers and may motivate customers to use sustainable power.

In some embodiments, a system that requests power-source data associated with power sources powering a device, receives or otherwise assigns sustainability factors associated with the power sources, and outputs a determined sustainability indicator based on the factors.

In some embodiments, a sustainability indicator shows cleanliness of a power source that powers a power device.

In some embodiments, the sustainability indicator is provided on the power device, e.g., on a user interface of the power device.

In some embodiments, the sustainability indicator can be provided on an application that monitors the power device, e.g., on a smartphone or laptop.

In some embodiments, a periodic report, e.g., a monthly report, can be provided to the operator of the power device.

In some embodiments, an alert can be provided to the operator of the power device when the power source changes.

In some embodiments, the sustainability indicator further can include a carbon footprint based on the power sources.

In some embodiment, sources of power can be fossil (oil, coal, natural gas), hydro, wind, solar, nuclear, and any other type of energy source.

In some embodiments, the source of power can change throughout the course of the day.

In some embodiments, based on the indicated power source, e.g., clean vs. fossil, a visible indicator can be produced in real-time.

In some embodiments, based on the indicated power source, control of the power device can be manipulated to power down the power device or reducing power to the power device.

In some embodiments, the source of power can be provided through a cloud/web application through to a mobile application or a power device directly.

In some embodiments, the systems and methods disclosed herein provide a simple way to promote sustainability by creating awareness and potentially drive customers to demand.

Various aspects and embodiments disclosed herein include systems and methods for interacting with power devices utilizing augmented reality technology. The power devices may include, for example, uninterruptible power supplies (UPSs), power distribution units (PDUs), building cooling equipment, or any other device which might be powered by electricity. The terms “power equipment,” “power device,” or simply “device” are used interchangeably herein. Although described with reference to power devices, embodiments disclosed herein may also or alternatively be used with any type of electrical device.

Aspects and embodiments disclosed herein are described as potentially being implemented on a smartphone, however, it should be recognized that these aspects and embodiments may also or alternatively be implemented on other forms of portable electronic devices, for example, tablets, laptop computers, head mounted displays, or any other form of portable electronic device known in the art. The terms “portable electronic device” and “portable computing device” are used interchangeably herein. In various embodiments, a smartphone or other portable electronic device may include a touch screen or other input mechanism through which an operator may interact with on the smartphone or other portable electronic device.

In one embodiment, a smartphone application, sometimes referred to as a smartphone app, may include software supporting a user interface for an electronic device or system with associated augmented reality features. The operator may open the smartphone app and may optionally be required to authenticate using a password, fingerprint, or some other security feature if security is an important consideration. In one embodiment, once an operator's credentials are entered in the smartphone app, they do not need to be entered again. In yet another embodiment, no credentials may be required at all. Additionally or alternatively, information from the smartphone, for example an IP address or user ID may automatically be sent to a security access system upon opening the app and the operator may be granted access to functionality for interacting with an electronic device commensurate with a previously established security level.

The above example was described with reference to an electronic device; however, it is to be understood that similar types of operations and methods may be performed in accordance with various embodiments with any of a number of different devices. The present disclosure is not limited to embodiments performed on or with any particular form of device.

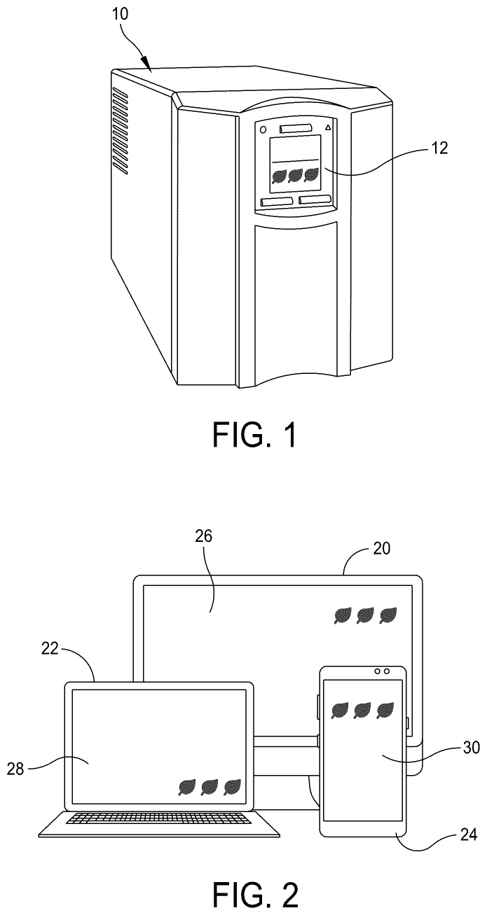

Referring to the drawings, and more particularly to FIG. 1, aspects of the present disclosure may be implemented within a power device, such as an uninterruptible power supply (UPS), which is generally indicated at 10. As is known, the UPS 10 may be coupled to an alternating current power supply and a load, which may include electronic equipment housed within an equipment rack. The UPS 10 may be configured to include an inverter configured to convert direct current (DC) to alternating current (AC) and a power factor controller (PFC) configured to convert input AC to DC and to provide power factor correction for the UPS. The UPS 10 further may include one or more batteries, which may be a lithium-ion battery, that is coupled to the inverter by a charger/DC-DC converter. The UPS 10 further may include a microcontroller that controls the operation of the constituent parts of the UPS. In one embodiment, the microcontroller may embody a small computer on an integrated circuit (IC) chip and may contain one or more central processing units (CPUs) along with memory and programmable inputs and outputs. The program memory can be on chip.

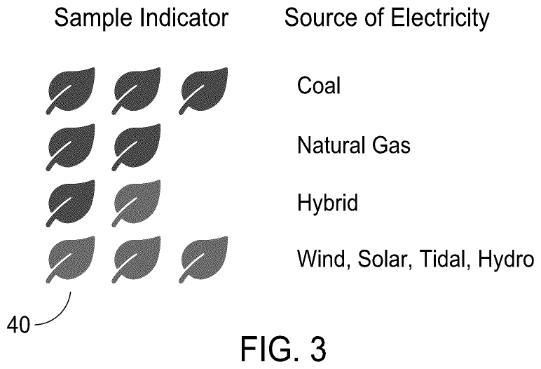

As shown, the UPS 10 includes a display 12, which includes an interface to control the operation of the UPS and to present information about the UPS to an operator. The display 12 of the UPS 10 may be configured to present to the operator an indication, sometimes referred to herein as a sustainability indicator, as to the source of power provided to the UPS 10. The sustainability indicator will be described in greater detail below with reference to FIGS. 2 and 3. The sustainability indicator provides the operator information about the source of power delivered to the UPS 10, specifically whether the source of power is clean or not clean.

The power device can be any type of power device, and not limited to UPSs. For example, the power device can include without limitation power distribution units (PDUs), power strips, and the like. The power device can also include items that consume power, such as household appliances. The power device should be configured with a display capable of showing the operator a sustainability indicator as described herein or be able to transmit information to remote device that is viewed by the operator.

Referring to FIG. 2, several remote devices are shown. For example, the remote device can include a monitor 20 of a personal computer, a laptop 22 and a handheld device 24, such as a smartphone. Other devices may include tablets, notebooks, and the like. Each remote device 20, 22, 24 includes a display having a user interface to control the operation of the remote device and to present information about the remote device to the operator. Specifically, monitor 20 includes display 26, laptop 22 includes display 28, and handheld device 24 includes display 30. The displays 26, 28, 30 of the respective remote devices 20, 22, 24 may be configured to present to the operator a sustainability indicator of the source of power provided to the remote device.

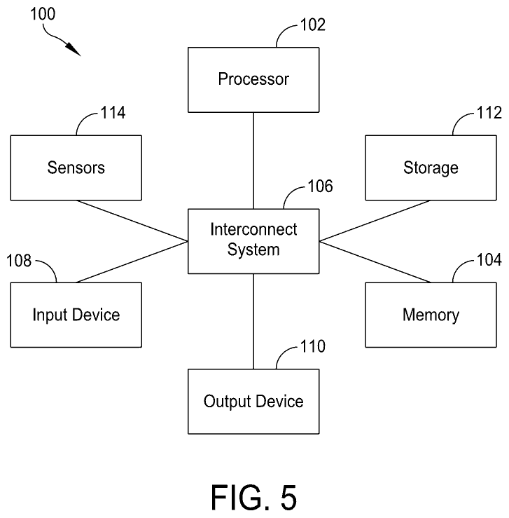

Embodiments of the present disclosure are directed to a system including a controller, e.g., control system 100 in FIG. 5, which is configured to 1) request power-source data associated with a plurality of power sources powering a device, 2) receive or otherwise assign a plurality of sustainability factors associated with the power-source data, 3) determine a sustainability indicator based on the plurality of sustainability factors, and 4) output the sustainability indicator. Power-source data can be received from a variety of sources, including but not limited to companies providing power to end users, e.g., utility companies. Power-source data also can be obtained from other sources, such as by government agencies. For example, the U.S. Energy Information Administration estimates that in 2023, about 4,178 billion kilowatt hours (kWh) (or about 4.18 trillion kWh) of electricity were generated at utility-scale electricity generation facilities in the United States. Of the total energy generated, about 60% was from fossil fuels, including coal, natural gas, petroleum, and other gases, about 19% was from nuclear energy, and about 21% was from renewable energy sources.

The power-source data is fed to the controller of the power device on a periodic basis by a suitable data network. In other embodiments, the power-source data can be fed to a controller that is separate from the power device but in communication with the power device. Data networks are used throughout the world for communication between individuals and organizations. Data networks can be connected to allow access to resources that are hosted outside of the particular provider. In one example, the Internet can be used to provide internetworking of the data network with a desired individual or organization. Terminals attached to IP networks, such as the Internet, are addressed using IP addresses, with protocols of the Internet protocol suite (TCP/IP) providing control and routing of messages across the IP data network. Examples of network structures that IP can be used across to efficiently route messages include cloud-based networks, wide area networks (WAN), metropolitan area networks (MAN), and local area networks (LAN).

The controller is configured to periodically receive or otherwise have assigned a plurality of sustainability factors associated with the power-source data. Sustainability is a multi-faceted concept including environmental, economic and social aspects. As used herein, sustainability factors are directed to environmental aspects, including but not limited to sources of power as being clean or renewable or fossil-based. For example, clean power sources may include energy generated from wind, solar, hydro, and tidal sources. Fossil-based power sources may include energy generated from coal, oil, and gas, with gas being considered cleaner than coal and oil since it burns cleaner. Gas can include natural gas and propane gas. Other sources of power, such a nuclear power, can be included as well. Energy generated from combined sources of clean, fossil-based, and nuclear sources may be considered as hybrid.

Once sustainability factors are obtained, the controller is configured to determine a sustainability indicator based on the sustainability factors. The sustainability indicators may include one or more icons that represent a source of electricity based on the sustainability factors. Referring to FIG. 3, in one example, icons, together indicated at 40, can be selected to depict a natural element, such as a leaf. Other types of icons can be used. As shown, when the source of energy is coal, the sustainability indicator is three red leaves. When the source of energy is natural gas, the sustainability indicator is two red leaves, the inference that energy generated from natural gas is slightly more sustainable than energy generated from coal. When the source of energy is a hybrid of clean and fossil-based energies, the sustainability factor is one red leaf and one green leaf, the inference that that energy generated from a combination of clean and fossil-based energy sources is more sustainable than energy generated from natural gas. And finally, when the source of energy is a clean source of energy, e.g., wind, solar or hydro, the sustainability indicator is three green leaves, the inference that clean sources of energy are more sustainable.

It should be understood that any type or types of icons may be used to inform the operator of power source. For example, for clean power sources, icons showing wind, solar, or hydroelectric may be used, and for fossil-based power sources, icons showing coal, oil, or gas may be used.

Referring back to FIGS. 1 and 2, the sustainability indicators 40 are displayed on the display of the UPS and the displays of the remote devices 20, 22, 24. Moreover, the controller can be configured to store the power-source data and generate periodic reports. For example, the controller can be configured to generate weekly or monthly reports on power provided to the power device, including but not limited to the type of power, the time periods types of power were delivered to the power device, and the percentages of the types of power. Further, controller can be configured to generate a signal based on a change in the plurality of sustainability factors. The signal may be visual, audible, or both.

In one embodiment, the controller is configured to control the power device, e.g., UPS 10, based on the sustainability factor. In one example, when the sustainability factor is other than a clean power source, e.g., a fossil-based power source, in addition to displaying the sustainability factor, the controller is configured to control the operation of the power device. In one example, the controller is configured to manipulate the power device to power down the power device or reduce power to the power device. In another example, the controller is configured to put the power device in a reduced power mode of operation, such as a sleep mode.

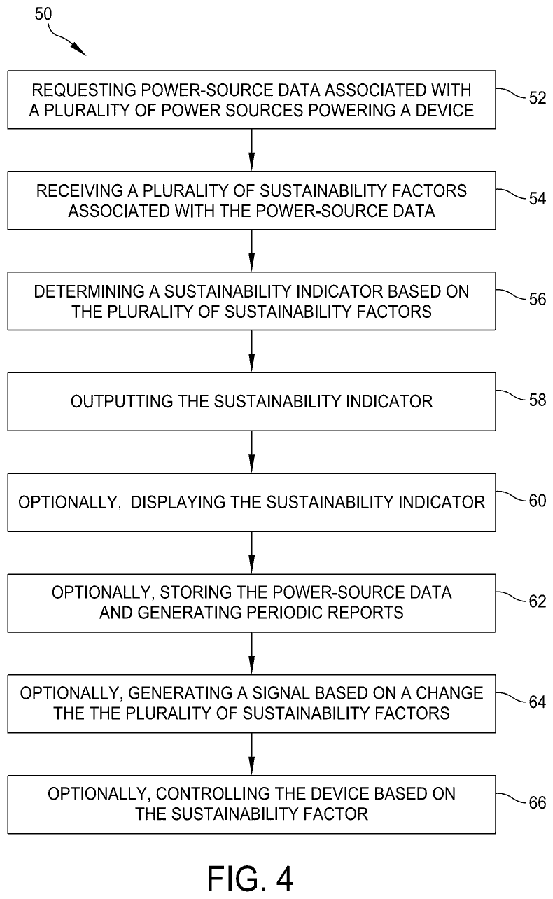

Referring to FIG. 4, a method of providing a sustainability indicator of a power source is generally indicated at 50. At step 52, the method 50 includes requesting power-source data associated with a plurality of power sources powering a device. As described above, the power-source data can be provided by a reliable source through a suitable network. Next, at step 54, the method 50 further includes receiving a plurality of sustainability factors associated with the power-source data. As described above, the sustainability factors associated with sources of power delivered to the particular device. Next, at step 56, the method 50 further includes determining a sustainability indicator based on the plurality of sustainability factors. As described above, the sustainability indicators may include one or more icons 40 that represent a source of electricity based on the sustainability factors. And finally, at step 58, the method 50 further includes outputting the sustainability indicator.

Optionally, at step 60, the method 50 further may include displaying the sustainability indicator on a display of the device or on a display of a controller associated with the device. As shown, the sustainability indicator can be displayed on the display of the UPS 10 or on displays of the remote devices. The operator is provided with a quick reference to the type of power that is delivered to the device.

Optionally, at step 62, the method 50 further may include storing the power-source data and generating periodic reports.

Optionally, at step 64, the method 50 further may include generating a signal to an operator based on a change in the sustainability factor.

Optionally, at step 66, the method 50 further may include controlling the device based on the sustainability factor. In one embodiment, in the event the sustainability factor is other than a clean power source, e.g., a fossil-based power source, the controller can be configured to control the operation of the device. For example, the controller can be configured to manipulate the device to power down the device or reduce power to the device. In another example, the controller can be configured to put the device in a reduced power mode of operation, such as a sleep mode.

Various controllers may execute various operations discussed herein. Using data stored in associated memory and/or storage, the controllers may also execute one or more instructions stored on one or more non-transitory computer-readable media that may result in manipulated data. In some examples, the controllers may include one or more processors or other types of controllers. In one example, the controllers are or include a commercially available, general-purpose processor. In another example, the controllers perform at least a portion of the operations discussed above using an application-specific integrated circuit tailored to perform particular operations in addition to, or in lieu of, a general-purpose processor. As illustrated by these examples, examples in accordance with the present invention may perform the operations described herein using many specific combinations of hardware and software and the invention is not limited to any particular combination of hardware and software components.

For example, aspects of the present disclosure may be implemented as specialized software executing in a general-purpose or specialized computer system 100, such as the system shown in FIG. 5. The computer system 100 may include a processor 102 connected to one or more memory devices 104, such as a disk drive, solid state memory, or other device for storing data. Memory 104 is typically used for storing programs and data during operation of the computer system 100.

Components of the computer system 100 may be coupled by an interconnection mechanism 106, which may include one or more busses (e.g., between components that are integrated within a same machine) and/or a network (e.g., between components that reside on separate discrete machines). The interconnection mechanism 106 enables communications (e.g., data, instructions) to be exchanged between system components of system 100. Computer system 100 includes one or more input devices 108, for example, a keyboard, mouse, trackball, microphone, or display screen, which may include a touch sensitive screen, through which an operator may issue commands or programming to the system 100. Computer system 100 includes one or more output devices 110, for example, a printing device, display screen, and/or a speaker, such as the displays shown in FIG. 2. One or more sensors 114 may also provide input to the computer system 100. These sensors 114 may include, for example, cameras associated with the remote devices or one or more other sensors capable of providing information to the computer system 100. In addition, the computer system 100 may contain one or more interfaces, including display 12 and displays 26, 28, 30, that connect computer system 100 to a communication network in addition to or as an alternative to the interconnection mechanism 106.

In some embodiments, a storage system 112 typically includes a computer readable and writeable nonvolatile recording medium in which signals are stored that define a program to be executed by the processor or information to be processed by the program. The medium may include, for example, a disk or flash memory. Typically, in operation, the processor causes data to be read from the nonvolatile recording medium into another memory that allows for faster access to the information by the processor than does the medium. This memory is typically a volatile, random access memory, such as a dynamic random access memory (DRAM) or static memory (SRAM). It may be located in storage system 112, as shown, or in memory system 104. The processor 102 generally manipulates the data within the integrated circuit memory 104, and then copies the data to a medium after processing is completed. A variety of mechanisms are known for managing data movement between the medium and the integrated circuit memory element 104, and embodiments disclosed herein are not limited to any particular data movement mechanism. Embodiments disclosed herein are not limited to a particular memory system 104 or storage system 112.

The computer system may include specially-programmed, special-purpose hardware, for example, an application-specific integrated circuit (ASIC). Embodiments disclosed herein may be implemented in software, hardware or firmware, or any combination thereof. Further, such methods, acts, systems, system elements and components thereof may be implemented as part of the computer system described above or as an independent component.

Although computer system 100 is shown by way of example as one type of computer system upon which various embodiments disclosed herein may be practiced, it should be appreciated that the embodiments disclosed herein are not limited to being implemented on the computer system as shown in FIG. 5. Various embodiments disclosed herein may be practiced on one or more computers having a different architecture or components that that shown in FIG. 5.

Computer system 100 may be a general-purpose computer system that is programmable using a high-level computer programming language. Computer system 100 also may be implemented using specially programmed, special purpose hardware. In computer system 100, processor 102 is typically a commercially available processor such as the well-known Pentium™ or Core™ class processors available from the Intel Corporation. Many other processors are available. Such a processor usually executes an operating system which may be, for example, the Windows 7 or Windows 8 operating system available from the Microsoft Corporation, the MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that embodiments disclosed herein are not limited to a particular computer system platform, processor, operating system, or network. Also, it should be apparent to those skilled in the art that the embodiments disclosed herein are not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various embodiments disclosed herein may be distributed among one or more computer systems configured to provide a service (e.g., servers) to one or more client computers, or to perform an overall task as part of a distributed system. For example, various embodiments disclosed herein may be performed on a client-server system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). In some embodiments one or more components of the computer system 600 may communicate with one or more other components over a wireless network, including, for example, a cellular telephone network.

It should be appreciated that embodiments disclosed herein are not limited to executing on any particular system or group of systems. Also, it should be appreciated that embodiments disclosed herein are not limited to any particular distributed architecture, network, or communication protocol. Various embodiments may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various embodiments disclosed herein may be implemented in a non-programmed environment (e.g., documents created in HTML, XML or other format that, when viewed in a window of a browser program, render aspects of a graphical-user interface (GUI) or perform other functions). Various embodiments disclosed herein may be implemented as programmed or non-programmed elements, or any combination thereof.

Having thus described several aspects of at least one embodiment of this invention, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

What is claimed is:

1. A system, comprising:
a controller configured to
request power-source data associated with a plurality of power sources powering a device,
assigning sustainability factors associated with the power-source data,
determine a sustainability indicator based on the plurality of sustainability factors, and
output the sustainability indicator.

2. The system of claim 1, further comprising a display configured to display the sustainability indicator.

3. The system of claim 2, wherein the display includes a user interface of a power device.

4. The system of claim 2, wherein the display includes a user interface of a remote device.

5. The system of claim 4, wherein the remote device includes one of a smartphone, tablet, laptop, notebook or personal computer having a monitor.

6. The system of claim 1, wherein the sustainability indicator includes one or more icons representing a source of electricity based on the plurality of sustainability factors.

7. The system of claim 6, wherein the source of electricity includes coal, natural gas, a hybrid source, and a clean source.

8. The system of claim 1, wherein the controller further is configured to store the power-source data and generate periodic reports.

9. The system of claim 1, wherein the controller further is configured to generate a signal based on a change in the plurality of sustainability factors.

10. The system of claim 1, wherein the controller further is configured to control the operation of the device based on the sustainability indicator.

11. A method of providing a sustainability indicator of a power source, the method comprising:
requesting power-source data associated with a plurality of power sources powering a device;
assigning a plurality of sustainability factors associated with the power-source data;
determining a sustainability indicator based on the plurality of sustainability factors; and
outputting the sustainability indicator.

12. The method of claim 11, further comprising displaying the sustainability indicator.

13. The method of claim 11, further comprising storing the power-source data and generating periodic reports.

14. The method of claim 11, further comprising generating a signal based on a change in the plurality of sustainability factors.

15. The method of claim 11, further comprising controlling the operation of the device based on the sustainability indicator.

16. A computer readable medium configured to cause a controller to perform a method of providing a sustainability indicator of a power source, the method comprising:
requesting power-source data associated with a plurality of power sources powering a device;
assigning a plurality of sustainability factors associated with the power-source data;
determining a sustainability indicator based on the plurality of sustainability factors; and
outputting the sustainability indicator.

17. The computer-readable medium of claim 16, wherein the method further comprises displaying the sustainability indicator.

18. The computer-readable medium of claim 17, wherein the sustainability indicator is displayed on a user interface of a power device.

19. The computer-readable medium of claim 17, wherein the sustainability indicator is displayed on a user interface of a remote device.

20. The computer-readable medium of claim 19, wherein the remote device includes one of a smartphone, tablet, laptop, notebook or personal computer having a monitor.

21. The computer-readable medium of claim 16, wherein the sustainability indicator includes one or more icons representing a source of electricity.

22. The computer-readable medium of claim 21, wherein the source of electricity includes coal, natural gas, a hybrid source, and a clean source.

23. The computer-readable medium of claim 16, further comprising storing the power-source data and generating periodic reports.

24. The computer-readable medium of claim 16, wherein the method further comprises generating a signal based on a change in the plurality of sustainability factors.

25. The computer-readable medium of claim 16, wherein the method further comprises controlling the operation of the device based on the sustainability indicator.
